(19) United States
(12) Patent Application Publication
(10) Pub. No.: US 2025/0071660 A1
(43) Pub. Date: Feb. 27, 2025

(54) METHODS AND APPARATUSES FOR HANDLING ESTABLISHMENT AND FAILURE IN MULTI-PATH CASE

(71) Applicant: Lenovo (Beijing) Limited, Beijing (CN)

(72) Inventors: Lianhai Wu, Beijing (CN); Mingzeng Dai, Shanghai (CN); Jing Han, Beijing (CN); Congchi Zhang, Shanghai (CN); Ran Yue, Beijing (CN)

(73) Assignee: Lenovo (Beijing) Limited, Beijing (CN)

(21) Appl. No.: 18/725,164

(22) PCT Filed: Dec. 30, 2021
(86) PCT No.: PCT/CN2021/143238

§ 371 Date: Jun. 28, 2024

(51) Int. Cl. H04W 40/24; H04W 76/19; H04W 76/20; H04W 92/18

(52) U.S. Cl. CPC H04W 40/248; H04W 76/19; H04W 76/20; H04W 92/18

(57) ABSTRACT

Embodiments of the present application relate to methods and apparatuses for handling establishment and failure in a multi-path case. According to an embodiment of the present application, a user equipment (UE) includes a processor and a transceiver coupled to the processor; and the processor is configured: to access a serving cell of a network node via a path, wherein the path is a direct path or an indirect path between the UE and the network node; to receive configuration information regarding a path addition procedure via the transceiver from the network node, wherein the path addition procedure is for adding a further path between the UE and the network node; to initiate the path addition procedure; and to start a timer related to the path addition procedure.

### TECHNICAL FIELD

Embodiments of the present application generally relate to wireless communication technology, in particular to methods and apparatuses for handling establishment and failure in a multi-path case.

### BACKGROUND

Vehicle to everything (V2X) has been introduced into 5G wireless communication technology. In terms of a channel structure of V2X communication, the direct link between two user equipments (UEs) is called a sidelink. A sidelink is a long-term evolution (LTE) feature introduced in 3GPP Release 12, and enables a direct communication between proximal UEs, and data does not need to go through a base station (BS) or a core network.

In the 3rd Generation Partnership Project (3GPP), deployment of a relay node (RN) in a wireless communication system is promoted. One objective of deploying a RN is to enhance the coverage area of a BS by improving the throughput of a user equipment (UE) that is located in the coverage or far from the BS, which can result in relatively low signal quality. A RN may also be named as a relay UE in some cases. A 3GPP 5G sidelink system including a relay UE may be named as a sidelink relay system.

Currently, in a 3GPP 5G New Radio (NR) system or the like, details regarding how to handle establishment and failure in a multi-path case has not been specifically discussed yet.

### SUMMARY

Some embodiments of the present application provide a user equipment (UE). The UE includes a processor and a transceiver coupled to the processor; and the processor is configured: to access a serving cell of a network node via a path, wherein the path is a direct path or an indirect path between the UE and the network node; to receive configuration information regarding a path addition procedure via the transceiver from the network node, wherein the path addition procedure is for adding a further path between the UE and the network node; to initiate the path addition procedure; and to start a timer related to the path addition procedure. In some embodiments, the timer related to the path addition procedure is started in response to: receiving the configuration information regarding the path addition procedure; or initiating the path addition procedure.

In some embodiments, the further path is the direct path in response to the path being the indirect path, and the further path is the indirect path in response to the path being the direct path.

In some embodiments, the configuration information regarding the path addition procedure is carried in a radio resource control (RRC) reconfiguration message including a reconfiguration with synchronization information element (IE). In some other embodiments, the configuration information regarding the path addition procedure is carried in a RRC reconfiguration message including path addition information. The path addition information includes at least one of: an identifier (ID) of the serving cell of the network node, in response to the path being the indirect path; an ID of a relay UE on the further path, in response to the path being the direct path; or radio bearer configuration information.

In some embodiments, the processor of the UE is configured to initiate a failure information procedure associated with the path addition procedure, in response to an expiry of the timer related to the path addition procedure. In an embodiment, during initiating the failure information procedure, the processor of the UE is configured to transmit a failure message including a failure type via the transceiver to the network node, and wherein the failure type includes at least one of: the expiry of the timer related to the path addition procedure; or a path addition failure. In an embodiment, after the expiry of the timer related to the path addition procedure or after initiating the failure information procedure, the processor of the UE is configured to fall back to use configuration information prior to initiating the path addition procedure.

In some embodiments, the processor of the UE is configured to transmit a RRC reconfiguration complete message via the transceiver to the network node, in response to successfully completing the path addition procedure. In an embodiment, the RRC reconfiguration complete message is transmitted via one path, and wherein a RRC reconfiguration message associated with the RRC reconfiguration complete message is received via the one path.

In some embodiments, after successfully completing the path addition procedure, the processor of the UE is configured to receive a further RRC reconfiguration message via the transceiver from the network node, wherein the further RRC reconfiguration message includes at least one of: an ID of a relay UE on the indirect path, and a release indication related to the indirect path; or an ID of the network node, and a further release indication related to the direct path.

Some embodiments of the present application provide a method, which may be performed by a UE. The method includes: accessing a serving cell of a network node via a path, wherein the path is a direct path or an indirect path between the UE and the network node; receiving configuration information regarding a path addition procedure from the network node, wherein the path addition procedure is for adding a further path between the UE and the network node; initiating the path addition procedure; and starting a timer related to the path addition procedure. In some embodiments, the timer related to the path addition procedure is started in response to: receiving the configuration information regarding the path addition procedure; or initiating the path addition procedure.

In some embodiments, the further path is the direct path in response to the path being the indirect path, and the further path is the indirect path in response to the path being the direct path.

In some embodiments, the configuration information regarding the path addition procedure is carried in a radio resource control (RRC) reconfiguration message including a reconfiguration with synchronization information element (IE). In some other embodiments, the configuration information regarding the path addition procedure is carried in a RRC reconfiguration message including path addition information. The path addition information includes at least one of: an identifier (ID) of the serving cell of the network node, in response to the path being the indirect path; an ID of a relay UE on the further path, in response to the path being the direct path; or radio bearer configuration information.

In some embodiments, the method further includes initiating a failure information procedure associated with the path addition procedure, in response to an expiry of the timer related to the path addition procedure. In an embodiment, the method further includes: during initiating the failure information procedure, transmitting a failure message including a failure type to the network node, and wherein the failure type includes at least one of: the expiry of the timer related to the path addition procedure; or a path addition failure. In an embodiment, the method further includes: after the expiry of the timer related to the path addition procedure or after initiating the failure information procedure, falling back to use configuration information prior to initiating the path addition procedure.

In some embodiments, the method further includes transmitting a RRC reconfiguration complete message to the network node, in response to successfully completing the path addition procedure. In an embodiment, the RRC reconfiguration complete message is transmitted via one path, and wherein a RRC reconfiguration message associated with the RRC reconfiguration complete message is received via the one path.

In some embodiments, the method further includes: after successfully completing the path addition procedure, receiving a further RRC reconfiguration message from the network node, wherein the further RRC reconfiguration message includes at least one of: an ID of a relay UE on the indirect path, and a release indication related to the indirect path; or an ID of the network node, and a further release indication related to the direct path.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned method performed by a UE.

Some embodiments of the present application also provide a UE. The UE includes a processor and a transceiver coupled to the processor; and the processor is configured: to access a serving cell of a network node via a path and a further path, wherein the path is a direct path between the UE and the network node, and wherein the further path is an indirect path between the UE and the network node; and to receive a radio resource control (RRC) reconfiguration message via the transceiver from the network node. In some embodiments, after receiving the RRC reconfiguration message, the processor of the UE is configured to transmit a RRC reconfiguration complete message via the transceiver to the network node.

In some embodiments, the processor of the UE is configured to select a path from the path and the further path, and wherein the RRC reconfiguration complete message is transmitted over the selected path. In some embodiments, the RRC reconfiguration complete message is transmitted over the path.

In some embodiments, after receiving the RRC reconfiguration message, the processor of the UE is configured: to autonomously release the indirect path in response to the network node releasing all data radio bearers (DRBs) in the indirect path; or to autonomously release the direct path in response to the network node releasing all DRBs in the direct path; or to release the indirect path in response to the network node releasing all DRBs and a signaling radio bearer (SRB) in the indirect path; or to release the direct path in response to the network node releasing all DRBs and a SRB in the direct path.

In some embodiments, after receiving the RRC reconfiguration message, the processor of the UE is configured to initiate a failure information procedure in response to at least one of: the path failed and the further path available; the further path failed and the path available; declaring an radio link failure (RLF) on a PC5 link between the UE and a relay UE on the further path; or receiving, from the relay UE, an indication of an RLF on a link between the relay UE and the network node. In an embodiment, the processor of the UE is further configured to start a timer in response to initiating the failure information procedure.

In some embodiments, the processor of the UE is configured to initiate a RRC re-establishment procedure in response to at least one of: the further path failed after the path failed and before the path being recovered; both the path and the further path suspended; both the path and the further path failed; or an occurrence of a failure for a primary path if the primary path is configured to the UE.

In some embodiments, during initiating the RRC re-establishment procedure, the processor of the UE is configured: to select a cell; and to transmit a RRC re-establishment request message to the selected cell. The RRC re-establishment request message may include one of: a cell radio network temporary identifier (C-RNTI), a physical cell identifier (PCI), and a short medium access control-identifier (MAC-I) associated with both the path and the further path; or a further C-RNTI, a further PCI and a further short MAC-I associated with a primary path if the primary path is configured to the UE, wherein the short MAC-I or the further short MAC-I is used to identify and verify the UE at the RRC re-establishment procedure.

Some embodiments of the present application also provide a method, which may be performed by a UE. The method includes: accessing a serving cell of a network node via a path and a further path, wherein the path is a direct path between the UE and the network node, and wherein the further path is an indirect path between the UE and the network node; and receiving a radio resource control (RRC) reconfiguration message from the network node. In some embodiments, the method further includes: after receiving the RRC reconfiguration message, transmitting a RRC reconfiguration complete message to the network node.

In some embodiments, the method further includes selecting a path from the path and the further path, and wherein the RRC reconfiguration complete message is transmitted over the selected path. In some embodiments, the RRC reconfiguration complete message is transmitted over the path.

In some embodiments, the method further includes: after receiving the RRC reconfiguration message, autonomously releasing the indirect path in response to the network node releasing all data radio bearers (DRBs) in the indirect path; or autonomously releasing the direct path in response to the network node releasing all DRBs in the direct path; or to release the indirect path in response to the network node releasing all DRBs and a signaling radio bearer (SRB) in the indirect path; or to release the direct path in response to the network node releasing all DRBs and a SRB in the direct path.

In some embodiments, the method further includes: after receiving the RRC reconfiguration message, initiating a failure information procedure in response to at least one of: the path failed and the further path available; the further path failed and the path available; declaring an radio link failure (RLF) on a PC5 link between the UE and a relay UE on the further path; or receiving, from the relay UE, an indication of an RLF on a link between the relay UE and the network node. In an embodiment, the method further includes starting a timer in response to initiating the failure information procedure.

In some embodiments, the method further includes initiating a RRC re-establishment procedure in response to at least one of: the further path failed after the path failed and before the path being recovered; both the path and the further path suspended; both the path and the further path failed; or an occurrence of a failure for a primary path if the primary path is configured to the UE.

In some embodiments, the method further includes: during initiating the RRC re-establishment procedure, selecting a cell and transmitting a RRC re-establishment request message to the selected cell. The RRC re-establishment request message may include one of: a cell radio network temporary identifier (C-RNTI), a physical cell identifier (PCI), and a short medium access control-identifier (MAC-I) associated with both the path and the further path; or a further C-RNTI, a further PCI and a further short MAC-I associated with a primary path if the primary path is configured to the UE, wherein the short MAC-I or the further short MAC-I is used to identify and verify the UE at the RRC re-establishment procedure.

Some embodiments of the present application also provide a network node (e.g., a base station (BS)). The network node includes a processor and a transceiver coupled to the processor; and the processor is configured to transmit configuration information regarding a path addition procedure via the transceiver to a user equipment (UE) via a path, wherein the path is a direct path or an indirect path between the UE and the network node, wherein the path addition procedure is for adding a further path between the UE and the network node. In some embodiments, the further path is the direct path in response to the path being the indirect path, and the further path is the indirect path in response to the path being the direct path.

In some embodiments, the configuration information regarding the path addition procedure is carried in a radio resource control (RRC) reconfiguration message including a reconfiguration with synchronization information element (IE). In some other embodiments, the configuration information regarding the path addition procedure is carried in a RRC reconfiguration message including path addition information. The path addition information includes at least one of: an identifier (ID) of the serving cell of the network node, in response to the path being the indirect path; an ID of a relay UE on the further path, in response to the path being the direct path; or radio bearer configuration information.

In some embodiments, the processor of the network node is configured to receive a failure message including a failure type via the transceiver from the UE, and wherein the failure type includes at least one of: an expiry of a timer related to the path addition procedure; or a path addition failure.

In some embodiments, the processor of the network node is configured to receive a RRC reconfiguration complete message via the transceiver from the UE, in response to the path addition procedure being successfully completed.

In some embodiments, the RRC reconfiguration complete message is transmitted via one path, and wherein the one path is selected by the network node to transmit a RRC reconfiguration message associated with the RRC reconfiguration complete message.

In some embodiments, the processor of the network node is configured to transmit a further RRC reconfiguration message via the transceiver to the UE, and wherein the further RRC reconfiguration message includes at least one of: an ID of a relay UE on the indirect path, and a release indication related to the indirect path; or an ID of the network node, and a release indication related to the direct path.

In some embodiments, the processor of the network node is configured to receive failure information via the transceiver from the UE, in response to at least one of: the path failed and the further path available; the further path failed and the path available; the UE declaring an radio link failure (RLF) on a PC5 link between the UE and a relay UE on the further path; or the UE receiving, from the relay UE, an indication of an RLF on a link between the relay UE and the network node.

Some embodiments of the present application provide a method, which may be performed by a network node (e.g., a BS). The method includes: transmitting configuration information regarding a path addition procedure to a user equipment (UE) via a path, wherein the path is a direct path or an indirect path between the UE and the network node, wherein the path addition procedure is for adding a further path between the UE and the network node.

In some embodiments, the further path is the direct path in response to the path being the indirect path, and the further path is the indirect path in response to the path being the direct path.

In some embodiments, the configuration information regarding the path addition procedure is carried in a radio resource control (RRC) reconfiguration message including a reconfiguration with synchronization information element (IE). In some other embodiments, the configuration information regarding the path addition procedure is carried in a RRC reconfiguration message including path addition information. The path addition information includes at least one of: an identifier (ID) of the serving cell of the network node, in response to the path being the indirect path; an ID of a relay UE on the further path, in response to the path being the direct path; or radio bearer configuration information.

In some embodiments, the method further includes receiving a failure message including a failure type from the UE, and wherein the failure type includes at least one of: an expiry of a timer related to the path addition procedure; or a path addition failure.

In some embodiments, the method further includes receiving a RRC reconfiguration complete message from the UE, in response to the path addition procedure being successfully completed.

In some embodiments, the RRC reconfiguration complete message is transmitted via one path, and wherein the one path is selected by the network node to transmit a RRC reconfiguration message associated with the RRC reconfiguration complete message.

In some embodiments, the method further includes transmitting a further RRC reconfiguration message to the UE, and wherein the further RRC reconfiguration message includes at least one of: an ID of a relay UE on the indirect path, and a release indication related to the indirect path; or an ID of the network node, and a release indication related to the direct path.

In some embodiments, the method further includes receiving failure information from the UE, in response to at least one of: the path failed and the further path available; the further path failed and the path available; the UE declaring an radio link failure (RLF) on a PC5 link between the UE and a relay UE on the further path; or the UE receiving, from the relay UE, an indication of an RLF on a link between the relay UE and the network node.

Some embodiments of the present application provide an apparatus. The apparatus includes: a non-transitory computer-readable medium having stored thereon computer-executable instructions, a receiving circuitry; a transmitting circuitry; and a processor coupled to the non-transitory computer-readable medium, the receiving circuitry and the transmitting circuitry, wherein the computer-executable instructions cause the processor to implement the abovementioned method performed by a network node (e.g., a BS).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIG. 2 illustrates an exemplary flowchart of a sidelink RRC reconfiguration procedure in accordance with some embodiments of the present application.

FIG. 3 illustrates an exemplary block diagram of an apparatus according to some embodiments of the present application.

FIG. 4 illustrates an exemplary signalling flow for multi-path establishment according to some embodiments of the present application.

FIG. 5 illustrates an exemplary signalling flow for path reconfiguration in a multi-path case according to some embodiments of the present application.

FIG. 6 illustrates an exemplary signalling flow for path release in a multi-path case according to some embodiments of the present application.

FIG. 7 illustrates an exemplary signalling flow for a path failure in a multi-path case according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd Generation Partnership Project (3GPP) LTE and LTE advanced, 3GPP 5G NR, 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

FIG. 1 illustrates a schematic diagram of a wireless communication system in accordance with some embodiments of the present application. As illustrated and shown in FIG. 1, a wireless communication system 100 includes at least two UEs (i.e., UE 101 and relay UE 102) and at least one BS (e.g., BS 103) for illustrative purpose. Although a specific number of UE(s) and BS(s) are depicted in FIG. 1, it is contemplated that any number of UE(s) and BS(s) may be included in the wireless communication system 100.

As shown in FIG. 1. UE 101 may communicate with BS 103 via a direct path between UE 101 and BS 103 or via an indirect path between the UE 101 and BS 103 through relay UE 102. In the embodiments of the present application, a direct path is a type of UE-to-Network (U2N) transmission path, where data is transmitted between a UE and the network without sidelink relaying. An indirect path is a type of U2N transmission path, where data is forwarded via a U2N Relay UE between a U2N Remote UE and the network. A U2N Relay UE is a UE that provides functionality to support connectivity to the network for U2N Remote UE(s). A U2N Remote UE is a UE that communicates with the network via a U2N Relay UE. In the embodiments of FIG. 1, UE 101 may be a U2N Remote UE, and relay UE 102 may be a U2N Relay UE.

UE(s) in the wireless communication system 100 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), internet of things (IoT) devices, or the like. According to some embodiments of the present application, UE(s) may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present application, UE(s) includes wearable devices, such as smart watches, fitness bands, optical head-mounted displays, or the like. Moreover, UE(s) may be referred to as a subscriber unit, a mobile, a mobile station, a user, a terminal, a mobile terminal, a wireless terminal, a fixed terminal, a subscriber station, a user terminal, or a device, or described using other terminology used in the art. UE(s) may communicate directly with BS(s) via UL communication signals.

In some embodiments of the present application, each of UE(s) may be deployed an IoT application, an enhanced mobile broadband (eMBB) application and/or an ultra-reliable and low latency communication (URLLC) application. It is contemplated that the specific type of application(s) deployed in UE(s) may be varied and not limited.

BS(s) in the wireless communication system 100 may be distributed over a geographic region. In certain embodiments of the present application, each of BS(s) may also be referred to as an access point, an access terminal, a base, a base unit, a macro cell, a Node-B, an evolved Node B (eNB), a gNB, a NG-RAN (Next Generation-Radio Access Network) node, a Home Node-B, a relay node, or a device, or described using other terminology used in the art. BS(s) is generally a part of a radio access network that may include one or more controllers communicably coupled to one or more corresponding BS(s). Each of BS(s) may include one or more cells. Each UE(s) may perform a cell section procedure between different cell(s) of different BS(s).

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G new radio (NR) of the 3GPP protocol, wherein BS(s) transmit data using an OFDM modulation scheme on the DL and UE(s) 101 transmit data on the UL using a single-carrier frequency division multiple access (SC-FDMA) or OFDM scheme. More generally, however, the wireless communication system 100 may implement some other open or proprietary communication protocols, for example, WiMAX, among other protocols.

In some embodiments of the present application, BS(s) in the wireless communication system 100 may communicate using other communication protocols, such as the IEEE 802.11 family of wireless communication protocols. Further, in some embodiments of the present application, BS(s) may communicate over licensed spectrums, whereas in other embodiments, BS(s) may communicate over unlicensed spectrums. The present application is not intended to be limited to the implementation of any particular wireless communication system architecture or protocol. In yet some embodiments of present application, BS(s) may communicate with UE(s) using the 3GPP 5G protocols.

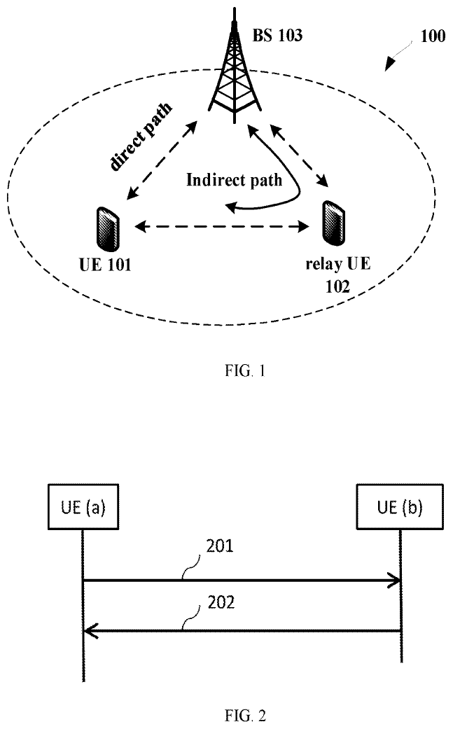

FIG. 2 illustrates an exemplary flowchart of a sidelink RRC reconfiguration procedure in accordance with some embodiments of the present application. As shown in FIG. 2, in step 201, UE (a) (e.g., UE 101 as illustrated and shown in FIG. 1) initiates a sidelink RRC reconfiguration procedure to UE (b) (e.g., relay UE 102 as illustrated and shown in FIG. 1) by transmitting RRC ReconfigurationSidelink message to UE (b).

If the sidelink RRC reconfiguration procedure is successfully completed, in step 202, UE (b) may transmit “a RRC reconfiguration complete sidelink message” to UE (a), e.g., RRCReconfigurationCompleteSidelink message as specified in 3GPP standard documents. Alternatively, if the sidelink RRC reconfiguration procedure is not successfully completed, in step 202, UE (b) may transmit “a RRC reconfiguration failure sidelink message” to UE (a), e.g., RRCReconfigurationFailure Sidelink message as specified in 3GPP standard documents.

The purpose of a sidelink RRC reconfiguration procedure is to modify a PC5 RRC connection, e.g., to establish, modify, or release sidelink data radio bearers (DRBs), to configure NR sidelink measurement and reporting, and to configure sidelink channel state information (CSI) reference signal resources.

A UE (e.g., UE (a) as illustrated and shown in FIG. 2) may initiate the sidelink RRC reconfiguration procedure and perform operations on the corresponding PC5 RRC connection in following cases:
a release of sidelink DRBs associated with a peer UE (e.g., UE (b) as illustrated and shown in FIG. 2);
an establishment of sidelink DRBs associated with the peer UE;
a modification for the parameters included in Sidelink radio bearer (SLRB)-Config of sidelink DRBs associated with the peer UE;
configuration information of the peer UE to perform NR sidelink measurement and report; and
configuration information of the sidelink CSI reference signal resources.

A UE capable of NR sidelink communication may initiate a procedure of sidelink UE information for NR, to report to a network or a BS that a sidelink radio link failure (RLF) (e.g., timer T400 expiry) or a sidelink RRC reconfiguration failure has been declared.

Embodiments of the present application aim to solve the issues including path establishment, path reconfiguration and path release in a multi-path case. Some embodiments of the present application study impacts when RRC reconfiguration message including reconfigurationWithSync IE is reused or not. Some embodiments of the present application study the principle to select one path for the transmission of RRC reconfiguration complete message after receiving a RRC reconfiguration message. Some embodiments of the present application introduce explicit and implicit solutions to release one path. Some other embodiments of the present application provide solutions of a failure case associated with multiple paths. Some embodiments of the present application study a case of a further path addition failure, a case in which one path fails if a UE has two available paths, and a case in which two paths fail if a UE has two available paths.

More details will be illustrated in the following text in combination with the appended drawings. Persons skilled in the art should well know that the wording “a/the first,” “a/the second” and “a/the third” etc. are only used for clear description, and should not be deemed as any substantial limitation, e.g., sequence limitation.

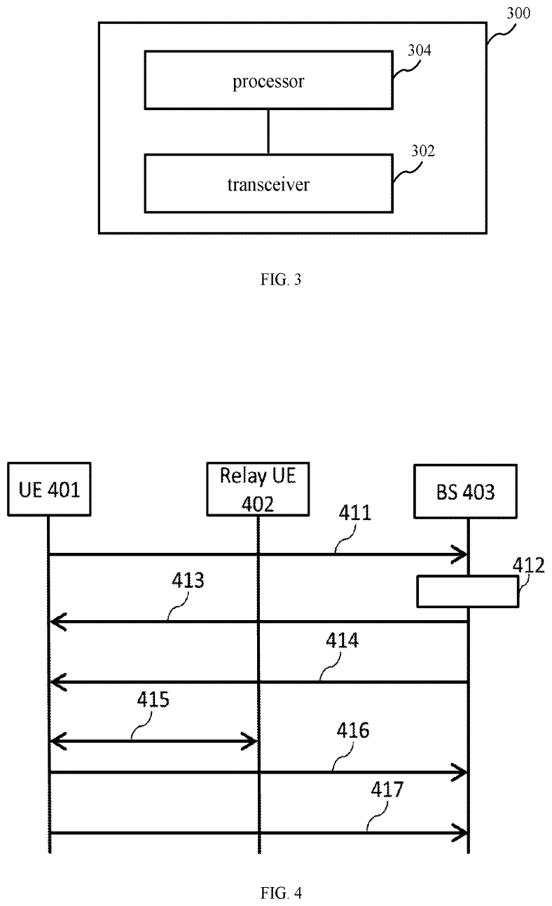

FIG. 3 illustrates an exemplary block diagram of an apparatus according to some embodiments of the present application. As shown in FIG. 3, the apparatus 300 may include at least one processor 304 and at least one transceiver 302 coupled to the processor 304. The at least one transceiver 302 may be a wired transceiver or a wireless transceiver. The apparatus 300 may be a UE or a network node (e.g., a BS).

Although in this figure, elements such as the at least one transceiver 302 and the processor 304 are described in the singular, the plural is contemplated unless a limitation to the singular is explicitly stated. In some embodiments of the present application, the transceiver 302 may be divided into two devices, such as a receiving circuitry and a transmitting circuitry. In some embodiments of the present application, the apparatus 300 may further include an input device, a memory, and/or other components.

According to some embodiments of the present application, the apparatus 300 may be a UE (e.g., UE 101 or UE (a) as shown and illustrated in FIG. 1 or FIG. 2). The processor 304 of the UE may be configured: to access a serving cell of a network node (e.g., BS 103 as shown and illustrated in FIG. 1) via a path, wherein the path is a direct path or an indirect path between the UE and the network node; to receive configuration information regarding a path addition procedure via the transceiver 302 of the UE from the network node, wherein the path addition procedure is for adding a further path between the UE and the network node; to initiate the path addition procedure; and to start a timer related to the path addition procedure. In some embodiments, the timer related to the path addition procedure is started in response to: receiving the configuration information regarding the path addition procedure; or initiating the path addition procedure.

In some embodiments, the further path is the direct path in response to the path being the indirect path, and the further path is the indirect path in response to the path being the direct path.

In some embodiments, the configuration information regarding the path addition procedure is carried in a radio resource control (RRC) reconfiguration message including a reconfiguration with synchronization information element (IE). In some other embodiments, the configuration information regarding the path addition procedure is carried in a RRC reconfiguration message including path addition information. The path addition information includes at least one of: an identifier (ID) of the serving cell of the network node, in response to the path being the indirect path; an ID of a relay UE (e.g., relay UE 102 as shown and illustrated in FIG. 1) on the further path, in response to the path being the direct path; or radio bearer configuration information.

In some embodiments, the processor 304 of the UE is configured to initiate a failure information procedure associated with the path addition procedure, in response to an expiry of the timer related to the path addition procedure. In an embodiment, during initiating the failure information procedure, the processor 304 of the UE is configured to transmit a failure message including a failure type via the transceiver 302 of the UE to the network node, and wherein the failure type includes at least one of: the expiry of the timer related to the path addition procedure; or a path addition failure. In an embodiment, after the expiry of the timer related to the path addition procedure or after initiating the failure information procedure, the processor 304 of the UE is configured to fall back to use configuration information prior to initiating the path addition procedure.

In some embodiments, the processor 304 of the UE is configured to transmit a RRC reconfiguration complete message via the transceiver 302 of the UE to the network node, in response to successfully completing the path addition procedure. In an embodiment, the RRC reconfiguration complete message is transmitted via one path, and wherein a RRC reconfiguration message associated with the RRC reconfiguration complete message is received via the one path.

In some embodiments, after successfully completing the path addition procedure, the processor 304 of the UE is configured to receive a further RRC reconfiguration message via the transceiver 302 of the UE from the network node, wherein the further RRC reconfiguration message includes at least one of: an ID of a relay UE (e.g., relay UE 102 as shown and illustrated in FIG. 1) on the indirect path, and a release indication related to the indirect path; or an ID of the network node, and a further release indication related to the direct path.

According to some other embodiments, the apparatus 300 may be a UE (e.g., UE 101 or UE (a) as shown and illustrated in FIG. 1 or FIG. 2). The processor 304 of the UE may be configured: to access a serving cell of a network node (e.g., BS 103 as shown and illustrated in FIG. 1) via a path and a further path, wherein the path is a direct path between the UE and the network node, and wherein the further path is an indirect path between the UE and the network node; and to receive a radio resource control (RRC) reconfiguration message via the transceiver 302 of the UE from the network node.

In some embodiments, after receiving the RRC reconfiguration message, the processor 304 of the UE is configured to transmit a RRC reconfiguration complete message via the transceiver 302 of the UE to the network node.

In some embodiments, the processor 304 of the UE is configured to select a path from the path and the further path, and wherein the RRC reconfiguration complete message is transmitted over the selected path. In some embodiments, the RRC reconfiguration complete message is transmitted over the path.

In some embodiments, after receiving the RRC reconfiguration message, the processor 304 of the UE is configured: to autonomously release the indirect path in response to the network node releasing all data radio bearers (DRBs) in the indirect path; or to autonomously release the direct path in response to the network node releasing all DRBs in the direct path; or to release the indirect path in response to the network node releasing all DRBs and a signaling radio bearer (SRB) in the indirect path; or to release the direct path in response to the network node releasing all DRBs and a SRB in the direct path.

In some embodiments, after receiving the RRC reconfiguration message, the processor 304 of the UE is configured to initiate a failure information procedure in response to at least one of: the path failed and the further path available; the further path failed and the path available; declaring an radio link failure (RLF) on a PC5 link between the UE and a relay UE (e.g., relay UE 102 as shown and illustrated in FIG. 1) on the further path; or receiving, from the relay UE, an indication of an RLF on a link between the relay UE and the network node. In an embodiment, the processor 304 of the UE is further configured to start a timer in response to initiating the failure information procedure.

In some embodiments, the processor 304 of the UE is configured to initiate a RRC re-establishment procedure in response to at least one of: the further path failed after the path failed and before the path being recovered; both the path and the further path suspended; both the path and the further path failed; or an occurrence of a failure for a primary path if the primary path is configured to the UE.

In some embodiments, during initiating the RRC re-establishment procedure, the processor 304 of the UE is configured: to select a cell; and to transmit a RRC re-establishment request message to the selected cell. The RRC re-establishment request message may include one of: a cell radio network temporary identifier (C-RNTI), a physical cell identifier (PCI), and a short medium access control-identifier (MAC-I) associated with both the path and the further path; or a further C-RNTI, a further PCI and a further short MAC-I associated with a primary path if the primary path is configured to the UE, wherein the short MAC-I or the further short MAC-I is used to identify and verify the UE at the RRC re-establishment procedure.

According to some embodiments, the apparatus 300 may be a network node (e.g., BS 103 as shown and illustrated in FIG. 1). The processor 304 of the network node may be configured: to transmit configuration information regarding a path addition procedure via the transceiver 302 of the network node to a UE (e.g., UE 101 or UE (a) as shown and illustrated in FIG. 1 or FIG. 2) via a path, wherein the path is a direct path or an indirect path between the UE and the network node, wherein the path addition procedure is for adding a further path between the UE and the network node. In some embodiments, the further path is the direct path in response to the path being the indirect path, and the further path is the indirect path in response to the path being the direct path.

In some embodiments, the configuration information regarding the path addition procedure is carried in a radio resource control (RRC) reconfiguration message including a reconfiguration with synchronization information element (IE). In some other embodiments, the configuration information regarding the path addition procedure is carried in a RRC reconfiguration message including path addition information. The path addition information includes at least one of: an identifier (ID) of the serving cell of the network node, in response to the path being the indirect path; an ID of a relay UE (e.g., relay UE 102 as shown and illustrated in FIG. 1) on the further path, in response to the path being the direct path; or radio bearer configuration information.

In some embodiments, the processor 304 of the network node is configured to receive a failure message including a failure type via the transceiver 302 of the network node from the UE, and wherein the failure type includes at least one of: an expiry of a timer related to the path addition procedure; or a path addition failure.

In some embodiments, the processor 304 of the network node is configured to receive a RRC reconfiguration complete message via the transceiver 302 of the network node from the UE, in response to the path addition procedure being successfully completed.

In some embodiments, the RRC reconfiguration complete message is transmitted via one path, and wherein the one path is selected by the network node to transmit a RRC reconfiguration message associated with the RRC reconfiguration complete message.

In some embodiments, the processor 304 of the network node is configured to transmit a further RRC reconfiguration message via the transceiver 302 of the network node to the UE, and wherein the further RRC reconfiguration message includes at least one of: an ID of a relay UE (e.g., relay UE 102 as shown and illustrated in FIG. 1) on the indirect path, and a release indication related to the indirect path; or an ID of the network node, and a release indication related to the direct path.

In some embodiments, the processor 304 of the network node is configured to receive failure information via the transceiver 302 of the network node from the UE, in response to at least one of: the path failed and the further path available; the further path failed and the path available; the UE declaring an radio link failure (RLF) on a PC5 link between the UE and a relay UE (e.g., relay UE 102 as shown and illustrated in FIG. 1) on the further path; or the UE receiving, from the relay UE, an indication of an RLF on a link between the relay UE and the network node.

In some embodiments of the present application, the apparatus 300 may include at least one non-transitory computer-readable medium. In some embodiments of the present disclosure, the non-transitory computer-readable medium may have stored thereon computer-executable instructions to cause a processor to implement the method with respect to a UE or a network node (e.g., a BS) as described above. For example, the computer-executable instructions, when executed, cause the processor 304 interacting with the transceiver 302, so as to perform operations of the methods, e.g., as described in view of FIGS. 4-7.

FIG. 4 illustrates an exemplary signalling flow for multi-path establishment according to some embodiments of the present application. The embodiments of FIG. 4 solve an issue regarding a path addition procedure. The embodiments of FIG. 4 refer to a successful path addition procedure. In the embodiments of FIG. 4, UE 401 (e.g., UE 101 or UE (a) as shown and illustrated in FIG. 1 or FIG. 2) may also be named as a remote UE. Relay UE 402 may be relay UE 102 as shown and illustrated in FIG. 1. BS 403 may be BS 103 as shown and illustrated in FIG. 1.

As shown in FIG. 4, in step 411, UE 401 accesses the serving BS (i.e., BS 403) via one link, e.g., a direct path or an indirect path. UE 401 stays at RRC connected state. UE 401 reports measurement result(s) based on configuration information from BS 403.

In step 412 as shown in FIG. 4, BS 403 decides to add a further path based on the measurement result(s). Then, in step 413 as shown in FIG. 4, BS 403 transmits a RRC reconfiguration message to UE 401.

In some embodiments, the RRC reconfiguration message including reconfigurationWithSync IE is reused to inform path addition. For instance, a target node ID and bearer configuration should be added in the RRC reconfiguration message as legacy. As legacy, one timer will be configured to control the path addition procedure. For example, a legacy timer, e.g., timer T304 can be reused if addition path is direct path.

In some other embodiments, the RRC reconfiguration message including path addition information, e.g., a target node ID and bearer configuration information is used as a path addition command. One timer may be started when UE 401 initiates a path addition procedure. When UE 401 receives a RRC reconfiguration message including path addition information, UE 401 starts the timer for path addition.

In step 414 as shown in FIG. 4, once UE 401 receives a RRC reconfiguration message for path addition, UE 401 starts the timer for path addition. In a case that UE 401 has a RRC connection with BS 403 via the direct path, the new addition path is an indirect path. UE 401 may start the timer, which is the same as the timer for path switching from the direct path to the indirect path. In a further case that UE 401 has a RRC connection with BS 403 via the indirect path, the new addition path is the direct path. UE 401 may start timer T304 (which is defined in 3GPP standard document TS38.331).

In step 415 as shown in FIG. 4, after UE 401 receives the RRC reconfiguration message for path addition, a PC5 connection between UE 401 and relay UE 402 is established. UE 401 may stop the timer once the PC5 connection is established.

In step 416 as shown in FIG. 4, UE 401 transmits a RRC reconfiguration complete message. UE 401 may stop the timer once the RRC reconfiguration complete message is transmitted (if the timer is not stopped in step 415). In step 417 as shown in FIG. 4, data transmission or data reception is performed.

Details described in all other embodiments of the present application (for example, details regarding how to handle multi-path establishment) are applicable for the embodiments of FIG. 4. Moreover, details described in the embodiments of FIG. 4 are applicable for all embodiments of FIGS. 1-3 and 5-7. It should be appreciated by persons skilled in the art that the sequence of the operations in exemplary procedure in the embodiments of FIG. 4 may be changed and some of the operations in exemplary procedure in the embodiments of FIG. 4 may be eliminated or modified, without departing from the spirit and scope of the disclosure.

FIG. 5 illustrates an exemplary signalling flow for path reconfiguration in a multi-path case according to some embodiments of the present application. In the embodiments of FIG. 5, UE 501 (e.g., UE 101 or UE (a) as shown and illustrated in FIG. 1 or FIG. 2) may also be named as a remote UE. BS 502 may be BS 103 as shown and illustrated in FIG. 1.

As shown in FIG. 5, in step 511, UE 501 accesses a serving BS (i.e., BS 502) via multi-path (e.g., a direct path and/or an indirect path). UE 501 stays at RRC connected state. For example, UE 501 may access the serving BS 502 via both a direct path between BS 502 and UE 501 and an indirect path between BS 502 and UE 501 via a relay UE (e.g., relay UE 102 as shown and illustrated in FIG. 1). UE 501 may report measurement result(s) based on configuration information from BS 502.

In step 512 as shown in FIG. 5, the serving BS 502 transmits a RRC reconfiguration message to UE 501 via one path. The configuration message could include the bearer configuration.

In step 513 as shown in FIG. 5, after UE 501 receives the RRC reconfiguration message from the serving BS 502, UE 501 will transmit a RRC reconfiguration complete message to the serving BS 502.

In some embodiments, the path receiving the reconfiguration message can be selected for transmitting the RRC reconfiguration complete message. In some further embodiments, the RRC reconfiguration complete message will be transmitted in the path over which the RRC reconfiguration message is received. In some other embodiments, any path can be selected for transmitting the RRC reconfiguration complete message, e.g., especially for the case that split SRB is configured.

Details described in all other embodiments of the present application (for example, details regarding how to handle establishment and failure in a multi-path case) are applicable for the embodiments of FIG. 5. Moreover, details described in the embodiments of FIG. 5 are applicable for all embodiments of FIGS. 1-4, 6, and 7. It should be appreciated by persons skilled in the art that the sequence of the operations in exemplary procedure in the embodiments of FIG. 5 may be changed and some of the operations in exemplary procedure in the embodiments of FIG. 5 may be eliminated or modified, without departing from the spirit and scope of the disclosure.

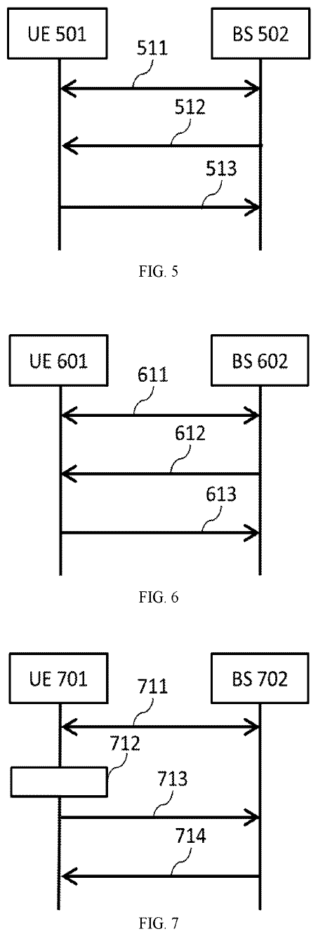

FIG. 6 illustrates an exemplary signalling flow for path release in a multi-path case according to some embodiments of the present application. In the embodiments of FIG. 6, UE 601 (e.g., UE 101 or UE (a) as shown and illustrated in FIG. 1 or FIG. 2) may also be named as a remote UE. BS 602 may be BS 103 as shown and illustrated in FIG. 1.

As shown in FIG. 6, in step 611, UE 601 accesses a serving BS (i.e., BS 602) via multi-path (e.g., a direct path and/or an indirect path). UE 601 stays at RRC connected state. For example, UE 601 accesses the serving BS 602 via both a direct path between BS 602 and UE 601 and an indirect path between BS 602 and UE 601 via a relay UE (e.g., relay UE 102 as shown and illustrated in FIG. 1). UE 601 may report measurement result(s) based on configuration information from the serving BS 602.

In step 612 as shown in FIG. 6, in a case that the serving BS 602 wants to release one of multiple paths, the serving BS 602 transmits a configuration message to UE 601.

In some embodiments, the serving BS 602 transmits a RRC reconfiguration message including a release indication and the corresponding node ID, e.g., the relay UE's ID or serving cell's ID. Other configuration, e.g., bearer configuration will also be included in the RRC reconfiguration message. Such embodiments provide an explicit release indication.

In some further embodiments, if the serving BS 602 releases all DRBs in one path, UE 601 will autonomously release this path. In some other embodiments, if the serving BS 602 releases all DRBs and SRB in one path, UE 601 will release this path. These embodiments provide an implicit release indication.

In step 613 as shown in FIG. 6, after UE 601 receives the RRC reconfiguration message including (explicitly or implicitly) the release information, UE 601 will transmit a RRC reconfiguration complete message to the serving BS 602. UE 601 will transmit the RRC reconfiguration complete message to the serving BS 602 via the available path, which is not released by the serving BS 602.

Details described in all other embodiments of the present application (for example, details regarding how to handle establishment and failure in a multi-path case) are applicable for the embodiments of FIG. 6. Moreover, details described in the embodiments of FIG. 6 are applicable for all embodiments of FIGS. 1-5 and 7. It should be appreciated by persons skilled in the art that the sequence of the operations in exemplary procedure in the embodiments of FIG. 6 may be changed and some of the operations in exemplary procedure in the embodiments of FIG. 6 may be eliminated or modified, without departing from the spirit and scope of the disclosure.

FIG. 7 illustrates an exemplary signalling flow for a path failure in a multi-path case according to some embodiments of the present application. In the embodiments of FIG. 7, UE 701 (e.g., UE 101 or UE (a) as shown and illustrated in FIG. 1 or FIG. 2) may also be named as a remote UE. BS 702 may be BS 103 as shown and illustrated in FIG. 1.

As shown in FIG. 7, in step 711, UE 701 accesses a serving BS (i.e., BS 702) via multi-path (e.g., a direct path and/or an indirect path). UE 701 stays at RRC connected state. For example, UE 701 accesses the serving BS 702 via both a direct path between BS 702 and UE 701 and an indirect path between BS 702 and UE 701 via a relay UE (e.g., relay UE 102 as shown and illustrated in FIG. 1). UE 701 may report measurement result(s) based on configuration information from the serving BS 702.

In step 712 as shown in FIG. 7, in a case that one path of multi-path fails, UE 701 initiates a failure information procedure once one path of two paths fails and another path is available. In some embodiments, when one of multi-path fails, UE 701 suspends the failed path and reports the failure information to the serving BS 702 via another available path. One timer could be needed to control the failure information procedure. UE 701 may start the timer once UE 701 initiates the failure information procedure. For a direct path failure, UE 701 may transmit the path failure message when UE 701 declares Uu RLF for the direct path. A failure type, e.g., timer T310 expiry or timer T312 expiry, can be added in the path failure message.

In some embodiments, for the indirect path, UE 701 will declare a RLF on path when one of the following occurs: a RLF on PC5 link, or the reception of Uu RLF. In some other embodiments, UE 701 initiates a path failure information procedure once UE 701 declares a RLF on PC5 link or UE 701 receives an indication of Uu RLF from the relay UE.

In step 713 as shown in FIG. 7, UE 701 transmits path failure information to the serving BS 702 via the available path. In step 714 as shown in FIG. 7, after BS 702 receives the path failure information, BS 702 will transmit a RRC reconfiguration message to UE 701.

Details described in all other embodiments of the present application (for example, details regarding how to handle establishment and failure in a multi-path case) are applicable for the embodiments of FIG. 7. Moreover, details described in the embodiments of FIG. 7 are applicable for all embodiments of FIGS. 1-6. It should be appreciated by persons skilled in the art that the sequence of the operations in exemplary procedure in the embodiments of FIG. 7 may be changed and some of the operations in exemplary procedure in the embodiments of FIG. 7 may be eliminated or modified, without departing from the spirit and scope of the disclosure.

The following texts describe specific Embodiments 1-3 of the methods as shown and illustrated in FIGS. 3-7. According to Embodiments 1-3, a UE (e.g., UE 101 or UE (a) as shown and illustrated in FIG. 1 or FIG. 2), a relay UE (e.g., relay UE 102 as shown and illustrated in FIG. 1), and a network node (e.g., BS 103 as shown and illustrated in FIG. 1) perform following operations.

### Embodiment 1

Embodiment 1 aims to solve issues regarding a path addition procedure and a path addition failure case. Embodiment 1 refers to an addition failure case. In Embodiment 1, following operations are performed.
(1) Step 1: A UE accesses a serving BS via one link, e.g., one of direct path and indirect path. The UE stays at RRC connected state.
   The UE may report measurement result(s) based on configuration information from the serving BS.
(2) Step 2: The serving BS decides to add another path based on the measurement result(s). The serving BS transmits a RRC reconfiguration message to the UE.
   Way #1: The RRC reconfiguration message including reconfiguration WithSync IE is reused to inform path addition.
      A target node ID and bearer configuration should be added in the RRC reconfiguration message as legacy.
      As legacy, one timer will be configured to control the path addition procedure. For example, legacy timer e.g., timer T304 can be reused if addition path is a direct path.
   Way #2: The RRC reconfiguration message including path addition information, e.g., a target node ID and bearer configuration information is used as a path addition command.
      One timer will be started when the UE initiates a path addition procedure. When the UE receives a RRC reconfiguration message including path addition information, the UE starts the timer for path addition.
(3) Step 3: Once the UE receives reconfiguration message for path addition, the UE starts the timer for path addition.
   Use case 1: The UE has a RRC connection with the serving BS via the direct path. The new addition path is an indirect path.
      The UE starts the timer, which is same as the timer for path switching from the direct path to the indirect path.
   Use case 2: The UE has a RRC connection with the serving BS via the indirect path. The new addition path is the direct path.
      The UE may start timer T304 (which is defined in 3GPP standard document TS38.331).
(4) Step 4: Once the timer for path addition expires, the UE initiates a failure information procedure for path addition.
   The synch Reconfiguration Failure can be reused to indicate the failure type, which is included in a failure information report.
   The content of failure message includes a failure type, e.g., a timer for path addition expiry or path addition failure, which can be differentiated from the normal path switching failure, e.g., synchReconfigFailure IE.
(5) Step 5: After the UE initiates the failure information procedure, the UE is expected to receive the reconfiguration message from the serving BS. Alternatively, the UE autonomously falls back the configuration information prior to path addition after the timer expires or the UE initiates the failure information procedure.

### Embodiment 2

Embodiment 2 aims to solve an issue regarding a path failure in a multi-path case. In Embodiment 2, following operations are performed.
(1) Step 1: A UE accesses a serving BS via multi-path (e.g., a direct path and/or an indirect path). The UE stays at RRC connected state.
   For example, the UE accesses the serving BS via both a direct path between the BS and the UE and an indirect path between the BS and the UE via a relay UE.
   The UE reports the measurement result based on configuration information from the serving BS.
(2) Step 2: One path of multi-path fails. The UE initiates a failure information procedure once one path of two paths fails and the other path is available.
   The UE transmits path failure information to the serving BS via the available path.
(3) Step 3: The other path also fails before the first failed path is recovered. The UE initiates a RRC re-establishment procedure.
   Point #2: If both paths are suspended or fail, the UE initiates a RRC re-establishment procedure.
(4) Step 4: The UE selects one suitable cell. The UE transmits a RRC re-establishment request message to the selected cell. The RRC re-establishment request message includes the following.
   Point #2: If both paths are suspended or fail, UE initiates re-establishment procedure.
      Re-establishment cause can reuse ‘other failure’.
      In legacy, C-RNTI, PCI and ShortMAC-I are included in the RRC re-establishment request message. In multi-path case, all C-RNTI, PCI and ShortMAC-I associated with both paths should be included.
(5) Step 5: The UE accesses the selected cell.

### Embodiment 3

Embodiment 3 also aims to solve an issue regarding a path failure in a multi-path case. In Embodiment 3, following operations are performed.
(1) Step 1: A UE accesses a serving BS via multi-path (e.g., a direct path and/or an indirect path). The UE stays at RRC connected state.
   For example, the UE accesses the serving BS via both a direct path between the BS and the UE and an indirect path between the BS and the UE via a relay UE.
   The UE reports the measurement result based on configuration information from the serving BS.
(2) Step 2: One path of the multi-path fails. If a primary path is configured, the UE initiates a RRC re-establishment procedure once a failure for primary path happens. (Point #3)
(3) Step 3: The UE selects one suitable cell. The UE transmits a RRC re-establishment request message to the selected cell. The RRC re-establishment request message includes the following.
   Point #3: If the primary path is configured, the UE initiates a RRC re-establishment procedure once a failure for primary path happens. For C-RNTI, PCI and ShortMAC-I associated with the primary path should be included.
(4) Step 4: The UE accesses the selected cell.

The method(s) of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.

1. A user equipment (UE), comprising:
at least one memory; and
at least one processor coupled with the at least one memory and configured to cause the UE to:
access a serving cell of a network node via a first path, wherein the first path is a direct path or an indirect path between the UE and the network node;
receive, from the network node, first configuration information for a path addition procedure that adds a second path between the UE and the network node;
initiate the path addition procedure; and
start a timer related to the path addition procedure.

2. The UE of claim 1, wherein one of the second path is the direct path in response to the first path being the indirect path, or the second path is the indirect path in response to the first path being the direct path.

3. The UE of claim 1, wherein the first configuration information is carried in a first radio resource control (RRC) reconfiguration message including a reconfiguration with a synchronization information element (IE).

4. The UE of claim 1, wherein the first configuration information is carried in a first radio resource control (RRC) reconfiguration message including path addition information, wherein the path addition information includes at least one of:
an identifier (ID) of the serving cell of the network node, in response to the first path being the indirect path;
an ID of a relay UE on the second path, in response to the first path being the direct path; or
radio bearer configuration information.

5. The UE of claim 1, wherein the timer related to the path addition procedure is started in response to:
receiving the first configuration information; or
initiating the path addition procedure.

6. The UE of claim 1, wherein the at least one processor is configured to cause the UE to initiate a failure information procedure associated with the path addition procedure, in response to an expiry of the timer related to the path addition procedure.

7. The UE of claim 6, wherein, to initiate the failure information procedure, the at least one processor is configured to cause the UE to transmit, to the network node, a failure message including a failure type, and wherein the failure type includes at least one of:
the expiry of the timer related to the path addition procedure; or
a path addition failure.

8. The UE of claim 6, wherein after the expiry of the timer related to the path addition procedure or after initiating the failure information procedure, the at least one processor is configured to cause the UE to fall back to use second configuration information prior to initiating the path addition procedure.

9. The UE of claim 1, wherein the at least one processor is configured to cause the UE to transmit a radio resource control (RRC) reconfiguration complete message to the network node, in response to successfully completing the path addition procedure.

10. The UE of claim 9, wherein the RRC reconfiguration complete message is transmitted via one path, and wherein a RRC reconfiguration message associated with the RRC reconfiguration complete message is received via the one path.

11. The UE of claim 1, wherein, after successfully completing the path addition procedure, the at least one processor is configured to cause the UE to receive a second RRC reconfiguration message from the network node, wherein the second RRC reconfiguration message includes at least one of:
an identifier (ID) of a relay UE on the indirect path, and a first release indication related to the indirect path; or
an ID of the network node, and a second release indication related to the direct path.

12. A user equipment (UE), comprising:
at least one memory; and
at least one processor coupled with the at least one memory and configured to cause the UE to:
access a serving cell of a network node via a first path and a second path, wherein the first path is a direct path between the UE and the network node, and wherein the second path is an indirect path between the UE and the network node; and
receive, from the network node, a radio resource control (RRC) reconfiguration message.

13. The UE of claim 12, wherein after receiving the RRC reconfiguration message, the at least one processor of the UE is configured to cause the UE to transmit a RRC reconfiguration complete message to the network node.

14. The UE of claim 13, wherein the at least one processor is configured to cause the UE to select a path from the first path and the second path, and wherein the RRC reconfiguration complete message is transmitted over the selected path.

15. The UE of claim 13, wherein the RRC reconfiguration complete message is transmitted over the first path.

16. The UE of claim 12, wherein, after receiving the RRC reconfiguration message, the at least one processor is configured to cause the UE to initiate a failure information procedure in response to at least one of:
the first path failed and the second path is available;
the second path failed and the first path is available;
declare a radio link failure (RLF) on a PC5 link between the UE and a relay UE on the second path; or
receive, from the relay UE, an indication of the RLF on a link between the relay UE and the network node.

17. The UE of claim 12, wherein the at least one processor is configured to cause the UE to initiate a RRC re-establishment procedure in response to at least one of:
the second path failed after the first path failed and before the first path was recovered;
both the first path and the second path are suspended;
both the first path and the second path failed; or
an occurrence of a failure for a primary path if the primary path is configured to the UE.

18. A method performed by a user equipment (UE), the method comprising:
accessing a serving cell of a network node via a first path, wherein the first path is a direct path or an indirect path between the UE and the network node;
receiving, from the network node, first configuration information for a path addition procedure that adds a second path between the UE and the network node;
initiating the path addition procedure; and
starting a timer related to the path addition procedure.

19. The method of claim 18, wherein one of the second path is the direct path in response to the first path being the indirect path, or the second path is the indirect path in response to the first path being the direct path.

20. A processor for wireless communication, comprising:
at least one controller coupled with at least one memory and configured to cause the processor to:
access a serving cell of a network node via a first path, wherein the first path is a direct path or an indirect path between a user equipment (UE) and the network node;
receive, from the network node, first configuration information for a path addition procedure that adds a second path between the UE and the network node;
initiate the path addition procedure; and
start a timer related to the path addition procedure.
